(19) United States
(12) Patent Application Publication
(10) Pub. No.: US 2025/0131470 A1
(43) Pub. Date: Apr. 24, 2025

(54) SEO FORECASTING FRAMEWORK TO MEASURE MEDIA EFFECTIVENESS IN ORGANIC DEMAND

(71) Applicant: Dell Products L.P., Round Rock, TX (US)

(72) Inventors: Renold Raj Devaraj, Bangalore (IN); Rahul Sarkar, Bangalore (IN); Rajeshwari Gauri Wallia, Woonona NSW (AU)

(21) Appl. No.: 18/490,710

(22) Filed: Oct. 19, 2023

(51) Int. Cl. G06Q 30/0242; G06N 20/20; G06Q 30/0251

(52) U.S. Cl. CPC G06Q 30/0244; G06N 20/20; G06Q 30/0256

(57) ABSTRACT

One example method includes using an ensemble including machine learning (ML) forecasting models, determining respective relationships between past media spends and changes in search engine optimization (SEO) driven consumer demand for a product or service, ranking the relationships according to a criterion, based on the ranking, generating a forecast that comprises recommended future media spends, and effects expected to be achieved by those future media spends, and implementing the recommended future media spends.

### FIELD OF THE INVENTION

Embodiments of the present invention generally relate to measuring media effectiveness. More particularly, at least some embodiments of the invention relate to systems, hardware, software, computer-readable media, and methods for, determining effects of media efforts in driving SEO-based demand.

### BACKGROUND

Currently, marketing teams often measure the impact of the media investments on demand/web traffic through paid channels using Media Mix Modeling (MMM). Because MMM is somewhat a universal model for media planning in organizations, MMM does not advise the kind of media investments that will impact SEO demand, that is, consumer demand that is driven or influenced by SEO, nor does it stipulate when to invest, and estimate their time to value, that is, the time that it takes for a media spend on SEO to result in a demonstrable influence on consumer demand. Hence, there is presently no effective model to measure the influence of media investments on the organic channels such as SEO. Although marketers believe that the spending on paid media will have an indirect impact on driving demand of unpaid channels such as SEO, it is hard to quantify that impact or even call out a particular media investment responsible for the largest influence on SEO demand. Also, ascertaining the time to realize the maximum value on SEO driven demand post spending on media channels has also been a challenge.

Thus, MMM approaches have various shortcomings. Particularly, MMM does not account for recent marketing activities for any recommendation, as it analyzes only historical quarters, or other time periods. Finally, MMM does not provide any insight on how much time it takes for a given marketing vehicle, or mix of marketing vehicles, to start impacting SEO demand and therefore revenue from Organic channels.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 is a comparative example of insights obtained from a conventional MMM approach.

FIG. 2 discloses aspects of hypothetical fiscal week wise media spend data.

FIG. 3 discloses aspects of a method for determining the impact of media spends on SEO (search engine optimization) in driving consumer demand, according to an embodiment.

FIG. 4 discloses aspects of a method for determining time to maximum value of media spends on SEO demand.

FIG. 5 is a graph illustrating the influence of media spend drivers on SEO demand for 11-12 quarters for a consumer product/service.

FIG. 6 shows marketing spend drives of SEO demand for the consumer product/service of FIG. 5.

FIG. 7 discloses aspects of an example method to determine the time needed for a particular media spend, on SEO efforts, to affect consumer demand for a product/service.

FIG. 8 discloses a computing entity operable to perform any of the disclosed methods, processes, and operations.

### DETAILED DESCRIPTION OF SOME EXAMPLE EMBODIMENTS

Embodiments of the present invention generally relate to measuring media effectiveness. More particularly, at least some embodiments of the invention relate to systems, hardware, software, computer-readable media, and methods for, determining effects of media efforts in driving SEO-based demand.

In one example embodiment, a first ensemble of forecasting models is created that may learn relationships between various media investments and SEO-driven consumer demand, such as for products and/or services for example. The forecasting models may be trained and validated incrementally on a rolling basis. The outputs of the models may comprise, for example, information demonstrating the correlation between one or more particular media investments in SEO, and any changes in consumer demand traceable to those media investments.

A second ensemble may be created that comprises forecasting models respectively associated with the media expenditures that were shown to correlate with, or cause, changes in SEO-based consumer demand. Each of these forecasting models may comprise information about these media expenditures, or media spend drivers, along with their respective lags, that is, the time between when the expenditure was made, and when the corresponding effect on consumer demand was determined to have occurred.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that a correlation and/or causation may be identified as between a media spend on SEO, and a change in SEO-driven consumer demand, and associated revenue. An embodiment may provide insights as to the amount of time that may be expected to elapse between a particular media spend on SEO, and a change in-driven consumer demand, and associated revenue. An embodiment may enable an organization to focus efforts and resources on media spends demonstrated to have a positive impact on consumer engagement, and revenue. Correspondingly, an embodiment may enable an organization to reduce, or avoid, expenditures on media efforts demonstrated to have only a limited, or no, effect on consumer engagement, and revenue. Various other advantages of one or more example embodiments will be apparent from this disclosure.

### A. Context for an Example Embodiment

The following is a discussion of a context for an embodiment of the invention. This discussion is not intended to limit the scope of the invention, or the applicability of the embodiments, in any way.

Web traffic is often considered analogous to demand for businesses selling online. Marketing and sales organization in any firm cater to individual consumers and businesses. Web traffic or site visits can be defined as the number of people visiting the company's website to check on products. Web traffic is generated using paid media channels through online and offline routes such as affiliate activities, online advertisements, search engine ads, social media marketing, TV and print advertisements. As well, web traffic is also generated through the unpaid organic channels such as Search Engine Optimization (SEO). In general, SEO involves optimizing product page content so that search engines like Google show that content near the top of the page when someone searches for something. This higher position of the content, or link to the content, in the search results may make it more likely to be seen by the searcher.

Reference is made herein to media vehicles and media spend drivers. In general, a media vehicle may be a specific television program, digital media, newspaper, magazine, radio station, or outdoor advertising location, for example, that can be employed to carry advertisements, or commercials, or any other marketing communications.

Media spending is sometimes referred to as taking place in an upper funnel (UF), or lower funnel (LF). The upper funnel is the beginning of the consumer journey, or where leads first come in. This is the stage where users are just starting their research, trying to find information on products or services needed or desired. There is usually a lot of research at this phase, including investigating different brands and what they have to offer. The media spends and activities directed at creating brand awareness are tagged to the upper funnel marketing.

On the other hand, people in the lower funnel are usually close to the action stage, that is, they are about ready to make a purchase. Those in the lower funnel may only need just a small incentive to choose a brand, and/or purchase a product. The media spends and activities directed at conversion, that is, to convince people to purchase the brand, are tagged to lower funnel marketing.

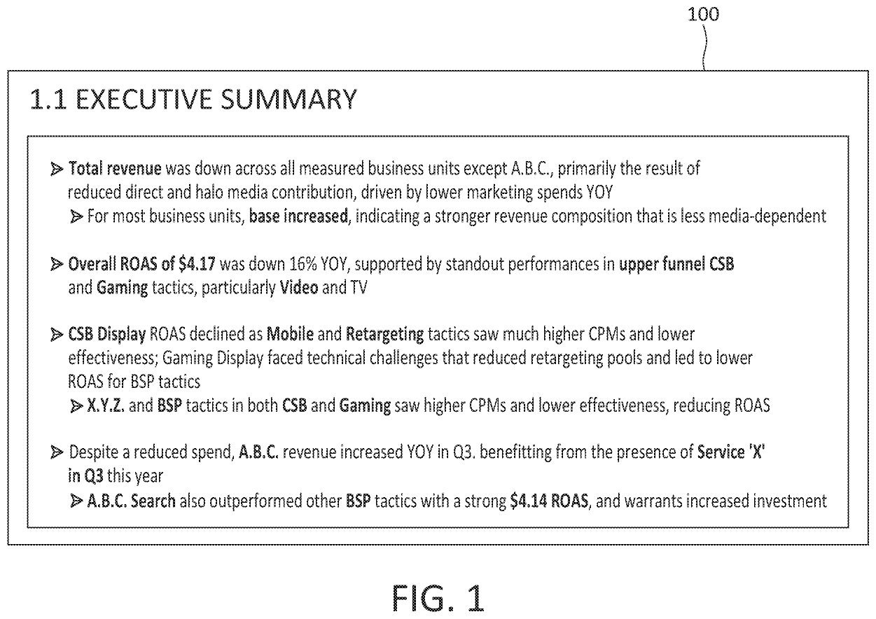

As noted earlier herein, conventional approaches to the timing and placement of media typically use the methodology of MMM (marketing/media mix modeling). This process may involves analyzing the historical quarters to ascertain the impact of the marketing campaigns, which may then lead to determining how various marketing vehicles contributed towards a goal—where the goal can be anything from demand generation to sales conversion. Some of the insights that a user may expect to come out of an MMM process may include: understanding the return you made from marketing; understanding the return you made from other factors; how much money you are getting back for every dollar you spent; and the optimum investment of media vehicles in the past. As these examples illustrate, MMM processes are backward-looking in nature in that they are focused on analyzing historical data, that is, attempting to answer the question “What happened in the past?,” and the insights derived are thus restricted to those historical time periods. MMM does not have the ability to look into the future, or to recommend any action item. FIG. 1 discloses a snapshot 100 of an example MMM executive summary.

As is apparent from FIG. 1, MMM does not: account for recent marketing activities for any recommendation, as it analyzes only historical time periods; forecast into the future to recommend vehicle spend mix; or, provide any insight on how much time it takes for any marketing vehicle to start impacting demand or sales. In contrast, one example embodiment may overcome these problems inherent in MMM, and so address matters that Go To Market (GTM)/Marketers would like to be equipped with to help their decision making for the future. Some example use cases are disclosed elsewhere herein.

### B. Detailed Discussion of Aspects of an Example Embodiment

### B.1 Brief Overview

An example embodiment comprises a data driven forecasting framework with an ensemble of TS (time series) models, and ML (machine learning) models. An embodiment of the framework may address the shortcomings in conventional approaches, and may provide marketers with various useful functionalities, such as: [1] a systematic way to determine which media investments are highly effective in terms of their effect on changing a level of SEO-driven consumer demand; and [2] determine an amount of time that a given investment, such as a media spend on SEO performance, takes to reach its maximum potential in terms of influencing consumer behavior such as sales. As such, an embodiment may help in the planning and execution of marketing campaigns and activities through these high impact media channels to drive maximum SEO demand during highly seasonal periods such as Black Friday, EOFY, and Cyber Monday, for example, so as to positively impact the revenue generated from SEO-driven consumer demand.

### B.2 Discussion

### B.2.1 Learning Relationships

An example embodiment may comprise an ensemble of forecasting models, such as TS models and/or ML models, that, in a first stage of an embodiment, may learn the relationships between various media investments and SEO-driven consumer demand to determine, using historical data, a group of top consistent media drivers. The historical data may span any amount of time. In one example embodiment, a historical time span of 3 years is used, but the scope of the invention is not limited to any particular length of time.

In an embodiment, about 3+years of historical data, with the order of importance of time, may be factored into this model as marketing strategies change as per market dynamics and consumer behavior. Multiple forecasting models of an ensemble may be built on 3+years of historical weekly media spends, and the corresponding SEO-driven consumer demand across the respective weeks. The TS and ML models of an ensemble according to one embodiment may be trained and validated incrementally on a rolling basis, such as an iterative process with a rolling window of 1 quarter for example, for future marketing planning with the aim of maximizing return on investment of media spends. It is noted that the ensemble modeling framework may be based on any algorithm capable of providing the relative importance of the features in a group of features, which may be useful in rank-ordering the various types of media as consumer demand drivers.

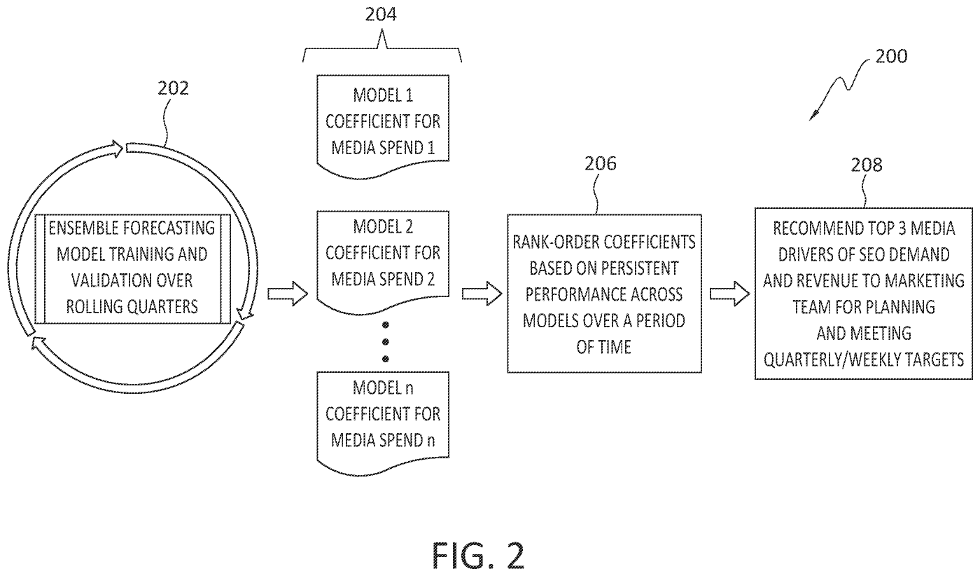

Turning now to FIG. 2, an example method 200 is disclosed that includes further details concerning identification of those media spends or other media activities that are most impactful with respect to SEO-driven consumer demand. As noted earlier herein, MMM used for planning the marketing investments in organizations does not systematically determine which marketing investments, such as media spends, have the maximum impact on SEO-driven consumer demand. In contrast, an embodiment as disclosed in FIG. 2, may identify the most impactful top ‘n’ consistent drivers of SEO demand to help marketers plan their campaign activities and to set targets for demand generation from organic channels for the future quarters.

Thus, the method 200 may begin with the creation 202 of an ensemble of forecasting models is created 202 that may learn relationships between various media investments and SEO-driven consumer demand, such as for products and/or services for example. Each of the models may correspond to a respective media effort. Also at 202, the forecasting models may be trained and validated incrementally on a rolling basis.

Next, each of the models may generate a respective coefficient 204 that identifies a relationship between the media spend associated with that model, and the impact of that media spend on SEO-driven consumer behavior. In an embodiment, a relatively large coefficient may indicate a close relationship between media spend and consumer behavior, and a relatively smaller coefficient may indicate a more distant, or attenuate, relationship between media spend and consumer behavior.

As such, the coefficients may be ranked 206. The ranking 206 may thus identify those media spends that closely correlate with, or cause, a change in consumer behavior. The rankings may then be used to recommend 208, such as to a marketing team, a particular course of action. For example, media efforts determined to be closely correlated to changes in consumer behavior may be likely candidates for future campaigns, while media efforts determined to have no/minimal effect on consumer behavior may not be further utilized by the marketing team.

### B.2.2 Determining Time to Impact

Another feature of an example embodiment, not present in conventional approaches such as MMM, is the ability, at a second stage of an embodiment, to identify the amount of time it takes for a given media effort or spend to measurably impact customer behavior. In this regard, it is useful to briefly discuss a concept sometimes referred to as ‘carry-over’ or ‘lagged effect’ of media drivers of SEO-based consumer demand, such as media spends on SEO.

Consider, for example, the advertisements that a person might see on television or on YouTube on a daily/weekly basis. Such a person typically does not run straight to the store, or open an ecommerce website, to buy the product or service right after seeing the ad for the first time. In fact, most generally do not buy a product or a service after the second viewing of a similar ad. Typically, it may be only after a person has seen the ads a few times over the past weeks, possibly supplemented with their own internet research, that a person ends up buying the product or service.

Thus, the buying of the product/service is a function of impact of ads seen not just from the week when the purchase was made, but also from the impact of the ads seen in the preceding weeks, that is, a decision to buy the product or service is built up in the mind of the consumer over a period of time. Thus, insights may be gained by capturing the media, such as advertisements, impact that has occurred in a preceding time period, such as the past week for example. The media impact occurring in this preceding time period may be referred to as the ‘lagged effect’ since the effect or impact resulting from the media effort may lag, in time, the time when the media effort was implemented.

The lagged effect may also be thought of as a time delay between when a media spend is made, and when a result of that media spend, such as consumer purchase of a product that was the subject of the media spend, is determined to have occurred. Thus, the week(s) following a media effort may be referred to as ‘lagged weeks.’ Depending on the particular use case, lagged weeks could be anywhere between 2 to 13 weeks, or more weeks, or fewer weeks, depending upon circumstances. The scope of the invention is not limited to any particular number of lagged weeks, or other lagged time periods. Following is a discussion of technical details and a methodology, for determining time to impact for a media effort, according to an embodiment.

In an embodiment, the data and the model set up may include:
Target: SEO Demand;
Predictors: Media spend drivers and its prior lag weeks up to 13 weeks (one quarter)+Seasonal/Holiday inputs; and
Methodology: Ensemble of forecasting models (time series+machine learning)

In an embodiment, an ensemble may be created that comprises separate respective forecasting models, which may comprise TS models and/or ML models, for each of the media spend drivers that were identified—in the first stage discussed above—as impactful, due to the learned relationships between those media spend drivers, and consumer actions such as purchases. These models may contain information about the original media spend driver and its lags up to ‘X’ weeks, such as 13 weeks or one quarter for example, along with other seasonal variables. FIG. 2 discloses an example snapshot 200 of a dataset such as might be used by TS and ML models to determine a time to impact of a given media effort, or media efforts.

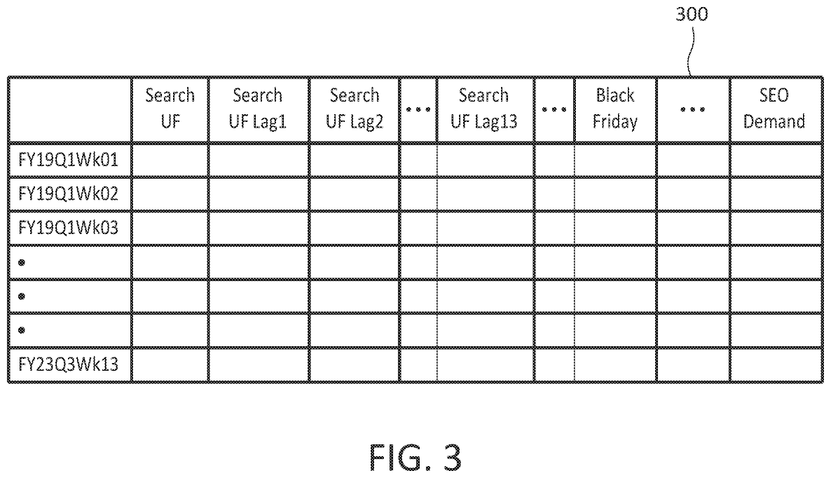

In particular, FIG. 3 discloses an example fiscal week-wise media spend in the snapshot 300. The snapshot 300 further includes fields for upper funnel and lower funnel search results performed at various lags, as well as a field for the Black Friday seasonal period, and a field indicating an identified effect on SEO demand that can be ascribed to a particular media effort that took place at a particular time.

In an embodiment, multiple forecasting ensemble models may be built which would aid in rank-ordering the lagged effects. As used herein, an example of ‘lagged effects’ may be as follows: the impact on SEO-driven consumer demand generated at time period t3 is a function of the respective media spends expended at time periods t1 and t2. As explained earlier herein, lags are included to account for the delayed impact of the spends on SEO demand and, in some circumstances, lags could vary between 2 and 6 weeks behind the media drivers. Note that the ensemble modeling framework can be based on any algorithm so long that framework is able to identify feature importance, which may be useful in rank-ordering the respective lags of the media spends.

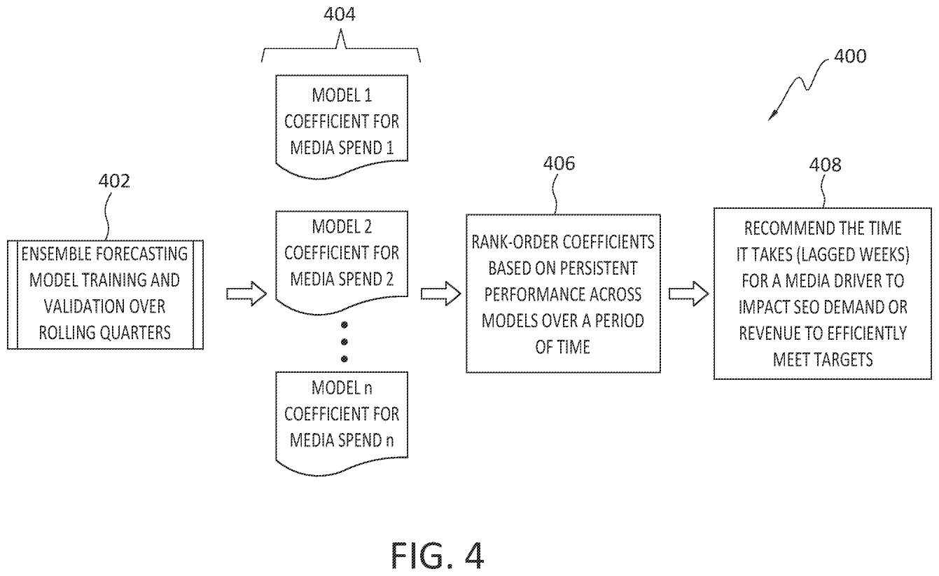

Turning now to FIG. 4, an example method 400 is disclosed that may be used to determine a time to maximum value, or impact, of media spends on SEO-driven consumer demand. It is well known that marketing efforts, such as media spends for example, take time to make any real impact on customer demand behavior, be it organic or paid. Consequently, it is a common phenomenon in marketing strategy to often start marketing efforts well in advance of a certain times and events, including seasonal events such as Black Friday and Cyber Monday. Thus, an embodiment may identify the time it takes for the media spends to impart their maximum impact on SEO-driven consumer demand.

In particular, FIG. 4 discloses an example method 400 that may begin with the creation 402 of an ensemble of forecasting models that may determine a time to impact of various media investments and SEO-driven consumer demand, such as for products and/or services for example. Each of the models may correspond to a respective media effort. Also at 402, the forecasting models may be trained and validated incrementally on a rolling basis.

Next, each of the models may generate a respective coefficient 404 that identifies a relationship between the media spend associated with that model, and the time to impact of that media spend on SEO-driven consumer behavior. In an embodiment, a relatively large coefficient may indicate a relatively short time between media spend and consumer behavior, and a relatively smaller coefficient may indicate a relatively long time between media spend and consumer behavior.

As such, the coefficients may be ranked 406. The ranking 406 may thus identify those media spends that are closely followed in time by a change in consumer behavior. The rankings may then be used to recommend 408, such as to a marketing team, a particular course of action. For example, media efforts determined be closely followed by corresponding consumer behavior may be likely candidates for future campaigns, while media efforts determined to take too long to affect consumer behavior may not be further utilized by the marketing team.

### B.2.3 Possible Outputs

One possible output that may be obtained by an embodiment is the media spend/driver performances over the multiple rolling forecasting models. The recommendation to a marketing team may be a top group, such as 3-5, of media drivers based on the consistency in their performance—which may be measured as impact on consumer behavior such as spending for example—gathered from the ensemble of models over the past rolling quarters.

Another possible output that may be obtained by an embodiment is the lagged performances, for each of the media drivers, over the multiple rolling forecasting models. Note that as used herein, a ‘media driver’ comprises a media spend or other media effort that produces a discernible impact on consumer behavior, such as consumer purchases for example. In an embodiment, a recommendation generated by an embodiment for use by a marketing team may be the best lagged week, or range of weeks, for a given media driver, or group of media drivers, based on the consistency in performance gathered from the ensemble of models.

To illustrate with a simple example, Lag5 may be found to be the most significant lagged effect feature, which indicates that Paid Search upper funnel media spends take about 5 weeks to show any real impact on SEO-driven consumer demand. An illustration using ARIMA with regression errors is explained below.

### C. Experiments and Results

One example embodiment has been tested using the Dell-ANZ small business marketing segment, with the details as follows:
Market scope: Dell—ANZ Small Business Segment
Data used: Historical weekly media spends across different channels and funnels such as affiliates—LF spends, Banner (Online Ads) UF and LF spends, Social media—UF & LF spends, Search LF & UF spends, TV—UF spends, Print LF & UF spends etc. and the SEO demand for the respective weeks
Historical Time span: 4 years is ideal (2 complete seasonal cycles of data)

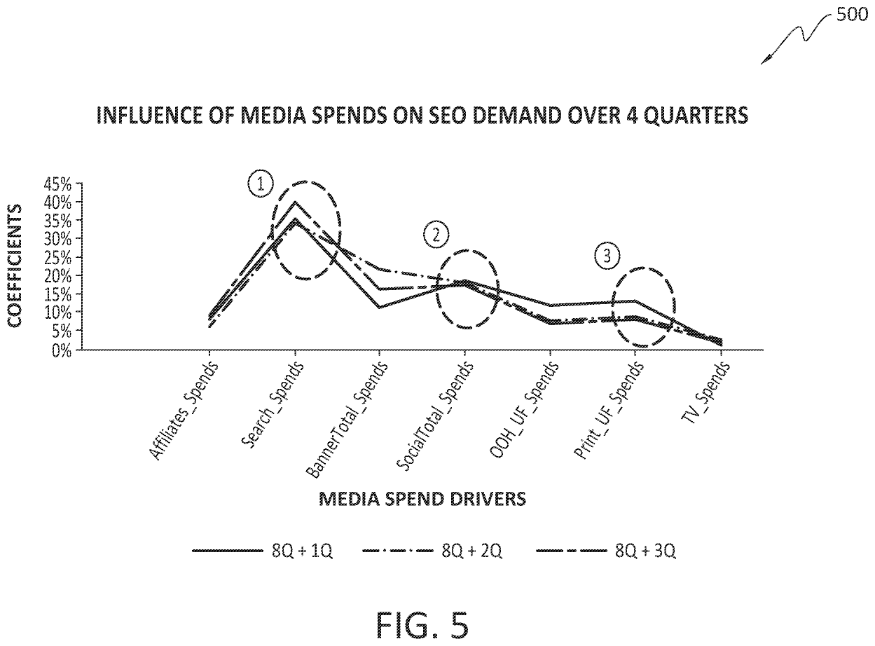

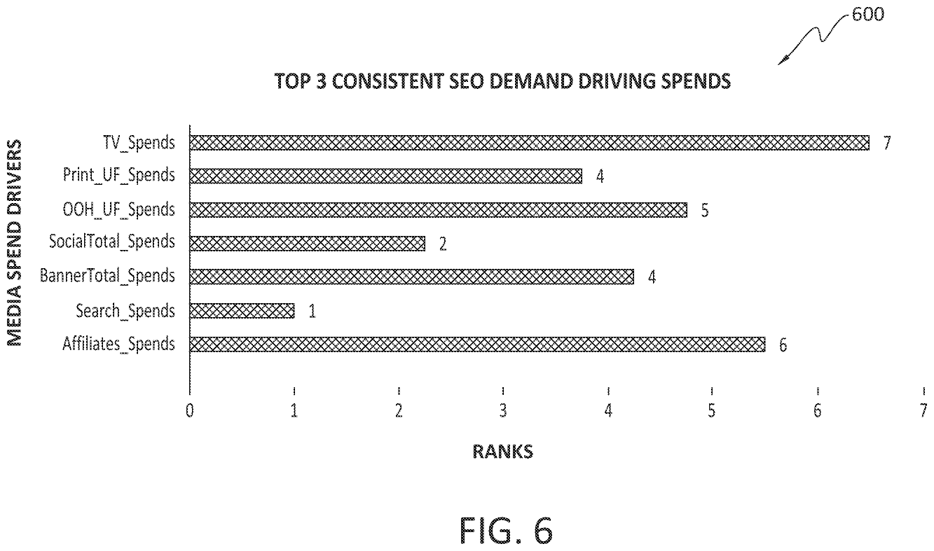

In this experiment, an ensemble of time series models was run on the Dell ANZ SB media spends vs. the SEO demand data for the past 8-12 quarters on a rolling basis. The most consistent impactful media spend drivers of SEO/organic demand are obtained by the magnitude of their coefficients across the rolling quarters. This is shown in FIG. 5, which includes a graph 500 that illustrates the influence of various media spend drivers on SEO demand for 11-12 quarters for Dell ANZ SB, and FIG. 6 which includes a graph 600 that illustrates the top three (3) consistent marketing spend drivers (TV_spends, affiliates_spends, and OOH_UF_spends) of SEO demand for Dell ANZ SB. In connection with this experiment, it was found that Search Lower Funnel (LF) spends, social media spends, and Print Upper Funnel (UF) spends, influence the SEO demand for Dell ANZ SB segment consistently across historical quarters and marketers could look at prioritizing these spends while planning for future promotions.

### D. Forecasting

In an embodiment, a model, such as a TS model for example, may comprise an ARIMA (Autoregressive integrated moving average) forecasting equation that may be used for time series analyses, such as analyses of time series data. Following is an example ARIMA equation such as may be employed by an embodiment for forecasting operations:

$$SEO = Intercept + B 0 * Marketing\_Driver + B 1 * Marketing\_Driver \_Lag1 + B 2 * Marketing\_Driver \_Lag2 + B 3 * Marketing\_Driver \_Lag3 + …$$

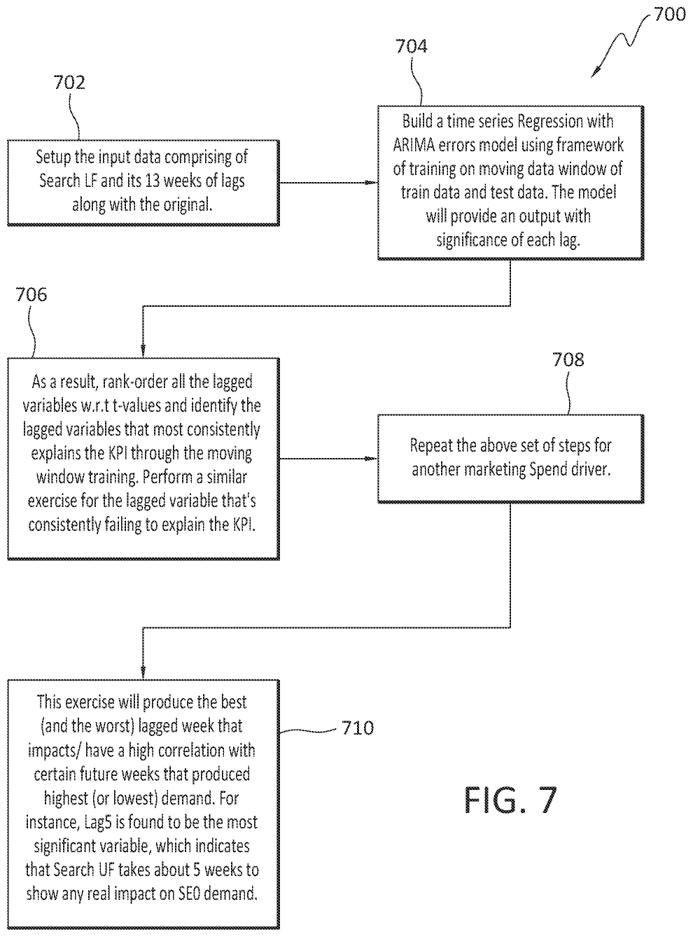

For instance, if the marketing spend driver Search LF is considered, the following method 700 of FIG. 7 may be carried out to obtain the results. Particularly, FIG. 7 discloses an example using Search UF to illustrate a modeling flow. Note that the experiment may be extended to build a full ARIMA time series model which could include only the best lagged features identified from each marketing vehicle from the earlier exercise. This could be a pragmatic consideration, as different marketing vehicles are often used together rather than in isolation. This could lead to creating a single model which may be able to capture the variance in SEO demand much better and provide an accurate forecast for efficient marketing planning and revenue maximization.

In the particular example of FIG. 7, the method 700 may begin by setting up 702 input data comprising Search LF and 13 weeks of lag, along with the original media spend driver. Next, a time series model may be built 704 using the framework employed in a first stage of an embodiment, as discussed earlier herein. Next, all the lagged variables may be rank ordered 706. At 708, the operations 702-706 may be repeated for each additional marketing spend driver. Finally, a result of the method 700 is a list of the best and worst lagged week that impact or correlate with certain future weeks that produced highest or lowest consumer demand.

### E. Example Methods

It is noted with respect to the disclosed methods, including the example method of FIGS. 2, 4 and 7, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: using an ensemble comprising machine learning (ML) forecasting models, determining respective relationships between past media spends and changes in search engine optimization (SEO) driven consumer demand for a product or service; ranking the relationships according to a criterion; based on the ranking, generating a forecast that comprises recommended future media spends, and effects expected to be achieved by those future media spends; and implementing the recommended future media spends.

Embodiment 2. The method as recited in any preceding embodiment, wherein the criterion is a respective coefficient generated for each of the ML models.

Embodiment 3. The method as recited in any preceding embodiment, wherein each of the ML models corresponds to a respective relationship.

Embodiment 4. The method as recited in any preceding embodiment, wherein one of the effects is a consumer purchase or other consumer behavior.

Embodiment 5. The method as recited in any preceding embodiment, wherein the ML models were trained and validated incrementally on a rolling basis using a rolling window of a specified length of time.

Embodiment 6. The method as recited in any preceding embodiment, further comprising, for each of the future media spends, generating a forecast of an amount of time expected to elapse between the future media spend and occurrence of the expected effect.

Embodiment 7. The method as recited in embodiment 6, wherein the expected effect is a consumer purchase or other consumer behavior.

Embodiment 8. The method as recited in embodiment 6, wherein the forecasts are generated based in part on an observed lagged effect for the past media spends and effects associated with the past media spends.

Embodiment 9. The method as recited in embodiment 6, wherein the forecast of an amount of time expected to elapse between the future media spend and occurrence of the expected effect is generated using an ensemble of time series models.

Embodiment 10. The method as recited in embodiment 6, wherein the forecast of an amount of time expected to elapse between the future media spend and occurrence of the expected effect is used to generate a recommendation for one or more future media spends.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

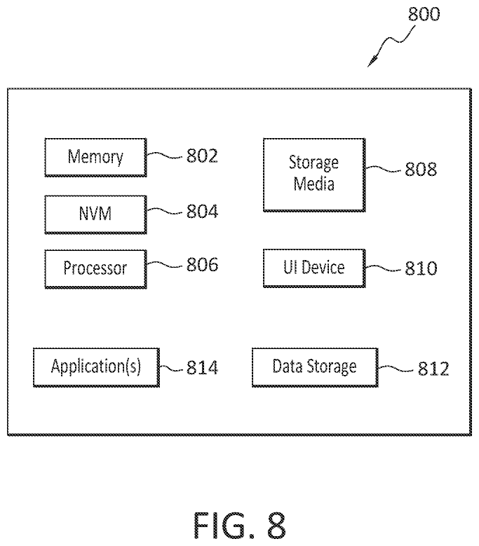

With reference briefly now to FIG. 8, any one or more of the entities disclosed, or implied, by FIGS. 1-7, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
using an ensemble comprising machine learning (ML) forecasting models, determining respective relationships between past media spends and changes in search engine optimization (SEO) driven consumer demand for a product or service;
ranking the relationships according to a criterion;
based on the ranking, generating a forecast that comprises recommended future media spends, and effects expected to be achieved by those future media spends; and
implementing the recommended future media spends.

2. The method as recited in claim 1, wherein the criterion is a respective coefficient generated for each of the ML models.

3. The method as recited in claim 1, wherein each of the ML models corresponds to a respective relationship.

4. The method as recited in claim 1, wherein one of the effects is a consumer purchase or other consumer behavior.

5. The method as recited in claim 1, wherein the ML models were trained and validated incrementally on a rolling basis using a rolling window of a specified length of time.

6. The method as recited in claim 1, further comprising, for each of the future media spends, generating a forecast of an amount of time expected to elapse between the future media spend and occurrence of the expected effect.

7. The method as recited in claim 6, wherein the expected effect is a consumer purchase or other consumer behavior.

8. The method as recited in claim 6, wherein the forecasts are generated based in part on an observed lagged effect for the past media spends and effects associated with the past media spends.

9. The method as recited in claim 6, wherein the forecast of an amount of time expected to elapse between the future media spend and occurrence of the expected effect is generated using an ensemble of time series models.

10. The method as recited in claim 6, wherein the forecast of an amount of time expected to elapse between the future media spend and occurrence of the expected effect is used to generate a recommendation for one or more future media spends.

11. A non-transitory storage medium having stored therein instructions that are executable by one or more hardware processors to perform operations comprising:
using an ensemble comprising machine learning (ML) forecasting models, determining respective relationships between past media spends and changes in search engine optimization (SEO) driven consumer demand for a product or service;
ranking the relationships according to a criterion;
based on the ranking, generating a forecast that comprises recommended future media spends, and effects expected to be achieved by those future media spends; and
implementing the recommended future media spends.

12. The non-transitory storage medium as recited in claim 11, wherein the criterion is a respective coefficient generated for each of the ML models.

13. The non-transitory storage medium as recited in claim 11, wherein each of the ML models corresponds to a respective relationship.

14. The non-transitory storage medium as recited in claim 11, wherein one of the effects is a consumer purchase or other consumer behavior.

15. The non-transitory storage medium as recited in claim 11, wherein the ML models were trained and validated incrementally on a rolling basis using a rolling window of a specified length of time.

16. The non-transitory storage medium as recited in claim 11, further comprising, for each of the future media spends, generating a forecast of an amount of time expected to elapse between the future media spend and occurrence of the expected effect.

17. The non-transitory storage medium as recited in claim 16, wherein the expected effect is a consumer purchase or other consumer behavior.

18. The non-transitory storage medium as recited in claim 16, wherein the forecasts are generated based in part on an observed lagged effect for the past media spends and effects associated with the past media spends.

19. The non-transitory storage medium as recited in claim 16, wherein the forecast of an amount of time expected to elapse between the future media spend and occurrence of the expected effect is generated using an ensemble of time series models.

20. The non-transitory storage medium as recited in claim 16, wherein the forecast of an amount of time expected to elapse between the future media spend and occurrence of the expected effect is used to generate a recommendation for one or more future media spends.
